(19) United States
(12) Patent Application Publication
(10) Pub. No.: US 2026/0276462 A1
(43) Pub. Date: Sep. 17, 2026

(54) Torque Sensor with Inductive Rotational Angle Measurement

(71) Applicant: NCTE AG, Oberhaching (DE)

(72) Inventors: Florian Eckschlager, Riemerling (DE); Robert Mutz, Grünwald (DE)

(21) Appl. No.: 19/565,129

(22) Filed: Mar. 12, 2026

(30) Foreign Application Priority Data
Mar. 17, 2025 (EP) 25164017.3

(51) Int. Cl. G01L 3/10; G01B 7/30; G01D 5/16; G01D 5/20

(52) U.S. Cl. CPC G01L 3/105; G01B 7/30; G01D 5/16; G01D 5/20; G01L 3/102

(57) ABSTRACT

A torque sensor comprises: a rotating magnetized component; a fixed magnetic field sensor assembly for detecting a magnetic field generated by the magnetized component when a torque is applied to the magnetized component; an evaluation device configured to determine the applied torque from the detected magnetic field; and a rotational angle sensor assembly for detecting a rotational angle of the magnetized component. The rotational angle sensor assembly comprises a fixed antenna element with at least one first antenna; a target element that is provided synchronously with the magnetized component, wherein the target element is configured to generate a response signal to the excitation signal that depends on an instantaneous rotational angle; the fixed antenna element comprises a second antenna for receiving the response signal and generating an induction signal based on the response signal. The evaluation device determines the instantaneous rotational angle of the target element and/or the magnetized component.

### CROSS-REFERENCE TO RELATED APPLICATIONS

This application claims priority to European Patent Application Serial No. 25164017.3, filed Mar. 17, 2025, the entire disclosure of which is hereby incorporated by reference.

### TECHNICAL FIELD

The invention relates to a torque sensor.

### BACKGROUND

Torque sensors are known in the prior art, for example, those installed in bottom brackets or drive bearings of pedelecs or e-bikes. An example of such a torque sensor, which is based on the principle of the inverse magnetostrictive effect, is disclosed in EP 3 050 790 B1. In this case, a magnetized shaft of the bearing generates a corresponding magnetic field outside the shaft in response to an applied torque, which can be detected without contact by a magnetic field sensor.

The measurement of magnetic field changes caused by torque can be carried out, for example, by measuring coils or magnetoresistive magnetic field sensors in a measuring circuit, which are influenced by the changing magnetic field. These are mounted contactlessly in relation to the magnetized shaft (e.g., parallel to the rotational axis) and detect magnetic field changes that occur under load due to inverse magnetostriction. The magnetic field change is usually directly proportional to the external force and establishes the connection with the torque. For this purpose, a one-time calibration is performed during the manufacturing phase of the torque sensor.

During calibration, any constant residual magnetic field present at the measuring position from the magnetized shaft without an applied torque is also taken into account by setting the zero point of a magnetic field-torque value curve, so that this residual magnetic field is assigned a torque value of zero.

Furthermore, EP 3 050 790 A1 discloses a torque sensor with speed measurement for a bottom bracket, wherein the speed is determined using a magnetic pole ring and a Hall sensor. The disadvantage here is the required size of the torque sensor due to the pole ring and the Hall sensor, as well as the lack of detection of the exact rotational angle. In addition, the pole ring can cause interference with the magnetic field generated by the magnetostrictive effect, thus causing measurement inaccuracies.

### SUMMARY

The invention is based on the problem of at least partially eliminating the aforementioned disadvantages of torque sensors known from the prior art.

This problem is solved by a torque sensor according to claim 1.

The torque sensor according to the present invention comprises a magnetized component mounted so as to be rotatable about a rotational axis; a fixed magnetic field sensor assembly with at least one magnetic field sensor for detecting a magnetic field generated by the magnetized component when a torque is applied to the magnetized component; an evaluation device configured to determine the applied torque from the detected magnetic field; and a rotational angle sensor assembly for detecting a rotational angle of the magnetized component. The rotational angle sensor assembly comprises a fixed antenna element with a transmitting antenna assembly for transmitting an excitation signal; a target element that is provided synchronously with the magnetized component and rotatably relative to the fixed antenna element, wherein the target element is configured to generate a response signal to the excitation signal that depends on a instantaneous rotational angle; and wherein the fixed antenna element comprises a receiving antenna arrangement for receiving the response signal and generating an induction signal based on the response signal. The evaluation device is further configured to determine the instantaneous rotational angle of the target element and/or the magnetized component based on the generated induction signal.

In this way, both the torque currently applied to the rotatable component and the corresponding current rotational angle can be determined.

The transmitting antenna assembly and the receiving antenna assembly can thus be inductively coupled via the target element. The excitation signal can have a frequency of several MHz (and thus also the response signal). The component can rotate around the rotational axis at a frequency of a several kHz or less. Torque measurements can be recorded at a frequency in the range of approximately 40 kHz to 100 kHz.

This can be further developed in that the rotatably mounted, magnetized component comprises a magnetized shaft. Alternatively, the rotatably mounted, magnetized component may comprise a disc or a spoked wheel that is arranged perpendicular to the rotational axis.

The magnetized component and the target element can form a structural unit.

These alternatives include advantageous alternatives for the rotatably mounted, magnetized component, depending on the structural conditions and requirements of the available free space.

The material of the target element can, for example, comprise an electrically conductive metal. The excitation signals emitted by the transmitting antenna assembly may induce eddy currents in the target element, which in turn induce a rotational angle-dependent signal in the receiving antenna assembly that may be detected and evaluated. The electrically conductive metal is preferably non-magnetic so that no magnetic fields are generated that interfere with the torque measurement (such as copper or aluminum). Alternatively, the target element may comprise a circuit board with an antenna element.

The target element may be at least partially disc-shaped, in particular comprising one or more sectors or segments of a circular disc or part of an annular disc.

According to another further embodiment, the magnetic field sensor may comprise at least one electrical coil or at least one magnetoresistive magnetic field sensor.

Magnetoresistive sensors for measuring magnetic fields are based, for example, on the AMR effect (anisotropic magnetoresistance), the GMR effect (giant magnetoresistance), the CMR effect (colossal magnetoresistance), the TMR effect (tunnel magnetoresistance), the EMR effect (extraordinary magnetoresistance) or the planar Hall effect.

Another further embodiment is that the antenna element can be configured as a disc, in particular an annular disc, arranged perpendicular to the rotational axis.

In another further embodiment, the magnetic field generated by the magnetized component may be dependent on the rotational angle, and the evaluation device may also be configured to determine the applied torque using the detected magnetic field generated by the magnetized component and the determined instantaneous rotational angle.

This may be further modified in that the magnetic field generated by the magnetized component may have a rotational angle-independent component and a rotational angle-dependent component, and wherein the evaluation device may further be configured to correct a measurement error of the determined torque due to the rotational angle-dependent component using the rotational angle-dependent component of the magnetic field and the determined instantaneous rotational angle.

According to another further embodiment, the evaluation device may be configured to determine a rotational speed/rotational frequency from a sequence of at least two determined rotational angles and at least one time difference between the determinations.

Another further embodiment consists in that the antenna element may be configured as a circuit board and the transmitting antenna assembly and the receiving antenna assembly may be provided as conductor tracks on the circuit board.

The invention also relates to a drive bearing, in particular a bottom bracket, with the torque sensor according to the present invention or one of the above-mentioned further embodiments.

In the drive bearing, the magnetized component can be a drive shaft, a disc, or a chainring.

The drive bearing can be provided in a pedelec or an e-bike.

Further features and exemplary embodiments as well as advantages of the present invention are explained in more detail below with reference to the drawings. It is understood that the embodiments do not limit the scope of the present invention. It is further understood that some or all of the features described below may also be combined with each other in other ways.

### BRIEF DESCRIPTION OF THE DRAWINGS

FIG. 1 shows a first embodiment of the torque sensor according to the present invention.

FIG. 2 shows a second embodiment of the torque sensor according to the present invention.

FIG. 3 shows a bottom bracket with the torque sensor according to the present invention.

### DETAILED DESCRIPTION

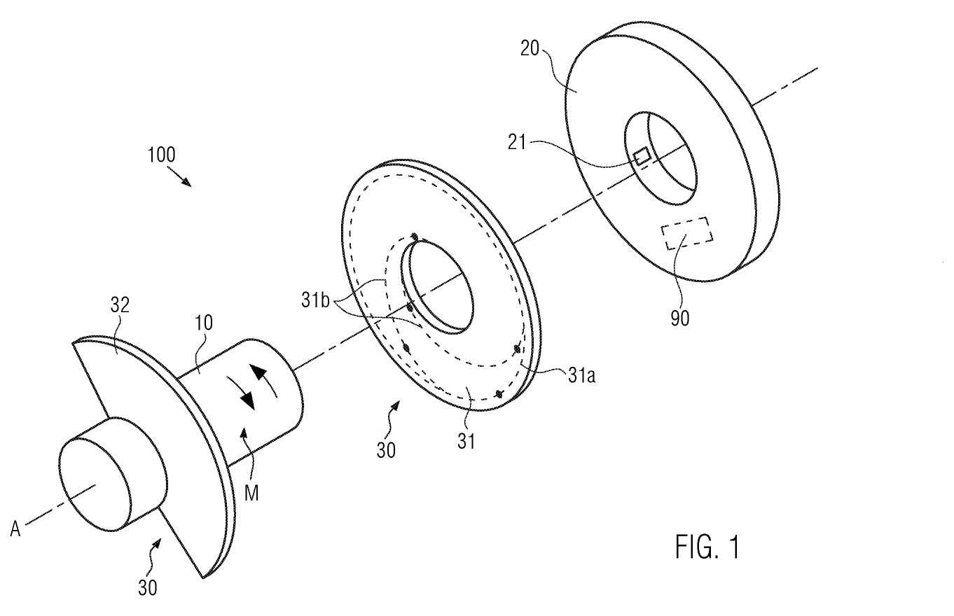

FIG. 1 shows a first embodiment of the torque sensor 100 according to the present invention.

The torque sensor 100 according to the present invention comprises a magnetized component 10 mounted so as to be rotatable about a rotational axis A; a fixed magnetic field sensor assembly 20 with at least one magnetic field sensor 21 for detecting a magnetic field M generated by the magnetized component 10 when a torque is applied to the magnetized component 10; an evaluation device 90, which is configured to determine the applied torque from the detected magnetic field; and a rotational angle sensor assembly 30 for detecting a rotational angle of the magnetized component 10. The magnetized component here is a magnetized shaft 10 made of steel, which is magnetized circumferentially in a region of the shaft 10. In particular, two adjacent areas may be magnetized in opposite directions, as shown in FIG. 1, which are detected by a magnetic field sensor 21 in each case.

The rotational angle sensor assembly 30 comprises a fixed antenna element 31 with a transmitting antenna assembly 31a for transmitting an excitation signal; a target element 32, which is provided synchronously with the magnetized component 10 and rotatably relative to the fixed antenna element 31, wherein the target element 32 is configured to generate a response signal to the excitation signal that depends on a current rotational angle; and wherein the fixed antenna element 31 comprises a receiving antenna assembly 31b for receiving the response signal and generating an induction signal based on the response signal. The target element 32 is made of metal such as copper or aluminum, for example materials. In this embodiment, the target element 32 is a half ring or partially disc-shaped on the shaft 10.

The antenna element 31 and the magnetic field sensor assembly 20 have central openings so that they are slidable onto the shaft 10. Then, the antenna element 31 is located close to the target element 32 and the magnetic field sensor assembly 20 is located above the magnetized region of the shaft 10.

The excitation signal has a frequency of several MHz. The component rotates at a frequency of several kHz or less. For the example of a pedelec, agricultural vehicle, or an e-bike, the rotational frequency is less than 10 Hz, while drive shafts in production machines can rotate at frequencies of up to several kHz. The usual frequencies of an oscillating circuit with coils as magnetic field sensors are in the range from 40 kHz to 100 kHz. In the case of a magnetoresistive magnetic field sensor, it is energized with frequencies of several kHz to measure the magnetic field. Therefore, the change in the excitation signal is many times faster than the measurement frequency of the magnetic field (by at least a factor of 100), so that induced currents or induced magnetic fields do not interfere with the torque measurement, but can be corrected as a constant background if necessary.

The evaluation device 90 is also configured to determine the current rotational angle of the target element 32 and/or the magnetized component 10 based on or using the generated induction signal.

The magnetic field sensors 11 are electrical coils 11. Alternatively or additionally, however, one or more magnetoresistive magnetic field sensors may also be arranged to detect the magnetic field generated by the magnetized component 10 when a torque is applied to the magnetized component 10.

The antenna element 31 is configured as a circuit board 31, and the transmitting antenna assembly 31a and the receiving antenna assembly 31b are provided as conductor tracks on the circuit board 31. In the example shown, the transmitting antenna assembly 31a comprises an antenna element 31a that runs around the outer edge of the circuit board 31. In the example shown, the receiving antenna assembly 31b comprises two antenna elements 31b arranged at a 90° angle to each other in the direction of rotation. However, the receiving antenna assembly 31b may also comprise two further antenna elements in conjunction with a further transmitting antenna assembly.

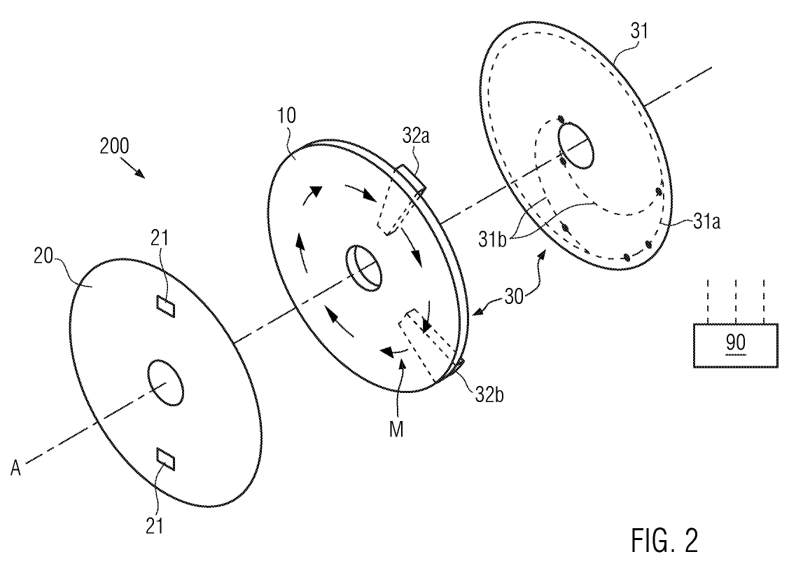

FIG. 2 shows a second embodiment of the torque sensor 200 according to the present invention.

In this embodiment, the magnetized component 10 is a disc 10 (or a spoked wheel) arranged perpendicular to the rotational axis A. The magnetized component 10 (disc 10) and the target element 32 may form a structural unit. Here, the target element 32 comprises, for example, segments or elements 32a, 32b, each in the form of a circular sector, or a part of an annular disc, on the side of the disc 10 facing the circuit board 31.

In particular, the magnetized component 10 may also have non-magnetic, electrically conductive elements that function as target elements 32, i.e., the magnetized component 10 and the target element 32 may be a single component. Here, the target element 32 comprises, for example, elements 32a, 32b, each in the form of a circular sector section, on the side of the disc 10 facing the circuit board 31.

In the first and second embodiments of torque sensors 100, 200, an (usually undesirable) asymmetrical magnetic field distribution dependent on the rotational angle in the circumferential direction of the shaft 10 (disc 10) can be corrected to enable correct torque determination at each instantaneous rotational angle. This asymmetry of the generated magnetic field is typically small compared to an average magnetic field averaged over a complete revolution of the shaft (disc 10). Such asymmetries can arise from an initial magnetization of the shaft 10 (disc 10) that is not completely homogeneous, or they can be caused by the influence of external fields after the initial magnetization.

Such incorrect magnetization can be corrected in the evaluation device 90 depending on the rotational angle in order to accurately determine the currently applied torque. Otherwise, one is limited, for example, to an average determination over a complete rotation.

The magnetic field generated by the magnetized component may have a rotational angle-independent component and a rotational angle-dependent component, and wherein the evaluation device may further be configured to correct a measurement error of the determined torque due to the rotational angle-dependent component using the rotational angle-dependent component of the magnetic field and the determined instantaneous rotational angle.

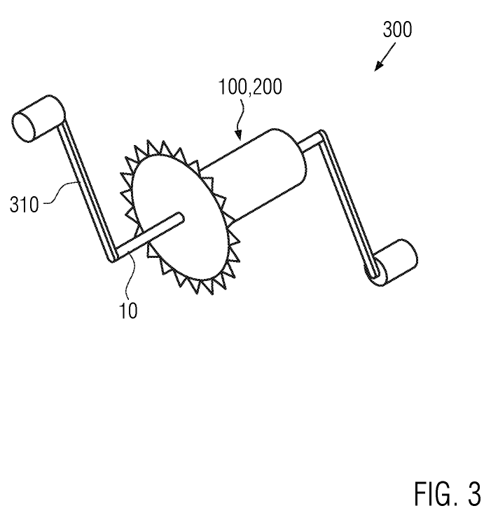

FIG. 3 shows a drive bearing or bottom bracket 300 with the torque sensor 100 or 200 according to the present invention as shown in FIGS. 1 or 2 .

Here, the torque is applied to the shaft 10 or chainring via a pedal crank 310 and/or a drive motor. The torque and rotational speed/rotational frequency are determined from a sequence of rotational angels and time difference between determinations. From this, further parameters such as the power input by a person or the drive motor can be determined.

The embodiments shown are merely examples, and the full scope of the present invention is defined by the claims.

What is claimed is:

1. A torque sensor, comprising:
a magnetized component rotatably mounted about a rotational axis;
a fixed magnetic field sensor assembly with at least one magnetic field sensor for detecting a magnetic field generated by the magnetized component when torque is applied to the magnetized component;
an evaluation device that determines the applied torque from the detected magnetic field; and
a rotational angle sensor assembly for detecting a rotational angle of the magnetized component, wherein the rotational angle sensor assembly comprises:
a fixed antenna element with at least one transmitting antenna assembly for transmitting an excitation signal;
a target element that is provided synchronously with the magnetized component and rotatably relative to the fixed antenna element, wherein the target element generates a response signal to the excitation signal that depends on a current rotational angle;
wherein the fixed antenna element comprises at least one receiving antenna assembly for receiving the response signal and generating an induction signal based on the response signal; and
wherein the evaluation device is further configured to determine an instantaneous rotational angle of the target element and/or the magnetized component based on the generated induction signal.

2. The torque sensor according to claim 1, wherein the rotatably mounted magnetized component comprises a magnetized shaft.

3. The torque sensor according to claim 1, wherein the rotatably mounted magnetized component comprises a disc or a spoked wheel arranged perpendicular to the rotational axis.

4. The torque sensor according to claim 3, wherein the magnetized component and the target element form a structural unit, in particular wherein the magnetized component and the target element are a single component.

5. The torque sensor according to claim 1, wherein material of the target element comprises a metal, in particular a non-magnetic, electrically conductive metal; or wherein the target element comprises a circuit board with an antenna element.

6. The torque sensor according to claim 1, wherein the target element is at least partially disc-shaped, in particular comprises one or more sectors or segments of a circular disc or one or more parts of an annular disc.

7. The torque sensor according to claim 1, wherein the magnetic field sensor comprises at least one electrical coil or at least one magnetoresistive magnetic field sensor.

8. The torque sensor according to claim 1, wherein the antenna element is configured as a disc, in particular an annular disc, arranged perpendicular to the rotational axis.

9. The torque sensor according to claim 1, wherein the magnetic field generated by the magnetized component is dependent on the rotational angle and the evaluation device is further configured to determine the applied torque using the detected magnetic field generated by the magnetized component and the determined instantaneous rotational angle.

10. The torque sensor according to claim 9, wherein the magnetic field generated by the magnetized component has a rotational angle-independent component and a rotational angle-dependent component, and wherein the evaluation device is further configured to correct a measurement error of the determined torque due to the rotational angle-dependent component using the rotational angle-dependent component and the determined instantaneous rotational angle.

11. The torque sensor according to claim 1, wherein the evaluation device is configured to determine a rotational speed/rotational frequency from a sequence of at least two determined rotational angles and at least one time difference between the determinations.

12. The torque sensor according to claim 1, wherein the antenna element is configured as a circuit board and the transmitting antenna assembly and the receiving antenna assembly are provided as conductor tracks on the circuit board.

13. A drive bearing, in particular a bottom bracket, comprising a torque sensor according to claim 1.

14. The drive bearing according to claim 13, wherein the magnetized component is a drive shaft, a disc, or a chainring.

15. A device comprising a drive bearing according to claim 13, wherein the device is a production machine, an agricultural vehicle, a pedelec, or an e-bike.
